(19) United States
(12) Patent Application Publication
(10) Pub. No.: US 2023/0219045 A1
(43) Pub. Date: Jul. 13, 2023

(54) DEVICE FOR ADDING AND MIXING AN ADDITIVE INTO A HYDRAULICALLY SETTABLE MIXTURE

(71) Applicant: SIKA TECHNOLOGY AG, Baar (CH)

(72) Inventors: Beat SCHNIDER, Luzern (CH); Heinz MEIER, Zürich (CH); Carsten RIEGER, Zürich (CH)

(73) Assignee: SIKA TECHNOLOGY AG, Baar (CH)

(21) Appl. No.: 18/008,649

(22) PCT Filed: Jul. 7, 2021
(86) PCT No.: PCT/EP2021/068899

§ 371 Date: Dec. 6, 2022

(30) Foreign Application Priority Data
Jul. 14, 2020 (EP) 20185754.7

(51) Int. Cl. B01F 25/313; B01F 25/431; B01F 25/433; B01F 35/10; B01F 23/47; B01F 23/451; B33Y 40/10; B28C 5/02

(52) U.S. Cl. CPC B01F 25/3133; B01F 23/47; B01F 23/451; B01F 25/3131; B01F 25/4337; B01F 25/31323; B01F 25/43161; B01F 25/431971; B01F 35/1452; B28C 5/026; B33Y 40/10; B01F 2101/28

(57) ABSTRACT

A device for adding and mixing an additive into a hydraulically settable mixture includes a tubular cavity for conducting the hydraulically settable mixture through in an intended flow direction, wherein a static flow-influencing element, in which there is an aperture that leads into the cavity and is intended for introducing the additive, projects into the cavity.

### TECHNICAL FIELD

The invention relates to a device for adding and mixing an additive into a hydraulically settable mixture, and an arrangement for delivering a hydraulically settable mixture. The invention also relates to the use of such devices in the production of shaped bodies by additive manufacturing and/or in the application of spray concrete or spray mortar. The invention likewise relates to a process for adding and mixing an additive into a hydraulically settable mixture.

### PRIOR ART

Metering or admixing small amounts of a substance, e.g. an additive, to a pumpable mixture is indispensable in many applications. Good mixing, however, is often difficult to achieve, in particular in the case of heterogeneous mixtures having a solids content. Problematic in particular is the metering of additives into hydraulically settable mixtures, which usually can have a relatively high solids content in the form of sand, gravel and cement with very different grain sizes and shapes. The addition of additives is made more difficult in particular in that hydraulically settable mixtures, such as concrete, constitute an extremely compact mass, which does not readily absorb liquid additives.

The use of dynamic mixers, for example, is known for the purpose of admixing additives. In this respect, the additive can be added to the hydraulically settable mixture, which is in a container, in a batchwise process and mixed in using rotary mixing elements. Continuous provision of hydraulically settable mixtures, however, is not possible with a batchwise process. In addition, in the case of batchwise processes, the space requirement rises with increasing production quantities.

Likewise known is the use of widened pipelines, in which, during delivery, the additive can be mixed into the hydraulically settable mixture using rotary mixing elements arranged in said pipelines.

DE 202 15 662 U1 (Tachus AG) describes for example a mixer in the form of an elongate pipe, in the case of which liquid concrete and accelerator are supplied separately and can be routed through a separate outlet after being mixed together. In this case, the mixing is done by rotary mixing elements. The system of DE 202 15 662 U1 makes it possible to produce quick-setting concrete in a continuous process, which concrete can then be used to form concrete parts by means of formwork.

However, dynamic mixers with rotary parts, seals and drives are susceptible to faults and require a high maintenance outlay.

Since the aggregates in concrete compositions moreover can be very large compared to typical conduit diameters, there is an increased risk of the aggregates becoming jammed in the rotary mixing elements and the delivery is abruptly blocked and interrupted (what are referred to as “blockages”).

Another metering approach is followed in the processing of spray concrete. Here, the spray concrete flows at high speed through a delivery conduit with an attached spray nozzle. Necessary formulation constituents, such as water (in the case of dry spray concrete), compressed air and additives (e.g. hardening accelerators) are then injected directly upstream of the spray nozzle and are mixed together, inter alia, in flight from the nozzle to the impact point, and also when they impact the other concrete constituents.

In this context, EP 1 570 908 A1 (Sika Technology AG) discloses e.g. a spray-concrete nozzle for applying wet spray concrete or dry spray concrete. The nozzle has lateral apertures, through which an additive can be metered into the spray concrete.

Although nozzles of this type do not have any rotary mixing elements, they are not suitable for providing poured concrete for relatively massive concrete components, for example, since the additives cannot be mixed into the concrete composition homogeneously enough.

Therefore, there is still a need for new approaches and improved solutions which, to the greatest possible extent, do not have the disadvantages mentioned above.

### SUMMARY OF THE INVENTION

An object of the present invention is to provide improved devices and processes for admixing an additive into a hydraulically settable mixture. The intention is preferably to find a solution with which an additive can be mixed into a hydraulically settable mixture as homogeneously and controlledly as possible prior to exiting an outlet nozzle. The solution should be usable for different hydraulically settable mixtures and as independently as possible of the processing technology.

Surprisingly, these objects are achieved by a device as claimed in claim 1. Accordingly, the core of the invention is a device for adding and mixing an additive into a hydraulically settable mixture, comprising a tubular cavity for conducting the pumpable mixture through in an intended flow direction, wherein a static flow-influencing element, in which there is an aperture that leads into the cavity and is intended for introducing the additive, projects into the cavity.

As has surprisingly been found, by virtue of the static flow-influencing element and the aperture therein, the additive can be introduced directly into the inner regions of the hydraulically settable mixture and at the same time homogeneously distributed in the mixture over a short distance. This results in very effective mixing. Since the flow-influencing element is a static element without movable parts, the susceptibility to faults and the maintenance outlay are much lower compared with dynamic mixing systems.

It has moreover been shown that the device according to the invention can be used in combination with various processing technologies. It is thus possible, for example, to add additives to concrete compositions that conventionally are dispensed to fill formwork via pipelines. It is therefore possible, for example, to activate long-retarded concrete using a liquid accelerator during delivery, with the result that the setting procedure is started. The device according to the invention is likewise suitable for admixing additives in the additive manufacture, e.g. 3D printing, of shaped bodies. In this respect, the additive, such as an accelerator or a thickening agent, can be added to the delivery conduit directly upstream of the printhead. In this respect, the device according to the invention has proven to be particularly advantageous, since the additive can be mixed in efficiently and homogeneously despite the high viscosity of the hydraulically settable mixtures conventionally used.

However, the device according to the invention can also be used for applying hydraulically settable mixtures in a dry or wet spraying process.

Extremely flexible use can therefore be made of the device according to the invention.

Further aspects of the invention are the subject of further independent claims. Particularly preferred embodiments of the invention are the subject of the dependent claims.

### Ways of Executing the Invention

A first aspect of the invention relates to a device for adding and mixing an additive into a hydraulically settable mixture, comprising a tubular cavity for conducting the pumpable mixture through in an intended flow direction, wherein a static flow-influencing element, in which there is an aperture that leads into the cavity and is intended for introducing the additive, projects into the cavity.

The “hydraulically settable mixture” is a mixture containing a hydraulic binder, which reacts in the presence of water to form solid hydrates or hydrate phases in a hydration reaction.

The mixture preferably moreover contains aggregates, water and, optionally, additives.

The hydraulic binder may be selected, for example, from mineral and/or organic binders. For example, the binder comprises cement, lime, hydraulic lime or gypsum, in each case alone, in the form of a mixture of several of the binders stated, or in a mixture with latently hydraulic binders and/or pozzolans. Aggregates are present in particular in the form of sand, gravel and/or rock aggregates. Organic binders may for example be epoxy-based or polyurethane-based binders.

The hydraulically settable mixture is particularly preferably a concrete composition or a mortar composition.

An “additive” is in particular a substance which can change the physical and/or chemical properties of the hydraulically settable mixture. It is preferably a solidification accelerator, hardening accelerator and/or a thickener.

In the present case, a “flow-influencing element” is understood to mean a body which projects into the cavity and influences the flow of the hydraulically settable mixture flowing through the cavity. The influencing can be effected in particular in the form of an at least partial change in the flow direction of the mixture and/or an at least partial separation of the mixture into partial flows.

The supplementary term “static” means that the flow-influencing element is secured immovably to the device and is not moved while the hydraulically settable mixture is being conducted through.

The device comprises a tubular cavity. In particular, this is a cylindrical pipe piece with an inlet and an outlet. In principle, however, the device may also have a different form. For example, the device may be in the form of a cuboidal element with a continuous bore.

The device consists in particular of metal and/or plastic, in particular of stainless steel.

The tubular cavity for conducting the hydraulically settable mixture through preferably has the form of a circular cylinder. However, other forms are also possible. In this way, the tubular cavity may also have a non-circular or a non-round cross section.

A fluid channel, through which the additive can be delivered to the aperture for introducing the additive, in particular from a region outside the cavity, preferably runs inside the flow-influencing element. This makes a particularly compact structure possible.

However, in principle it is also possible to feed in the additive through a fluid channel running outside the flow-influencing element.

A fluid inlet, which communicates with the aperture for introducing the additive and through which the additive can be fed in, is particularly preferably present on an outer side of the device in the region of the flow-influencing element. The device can thus be connected directly to a delivery device for the additive.

According to another embodiment, however, it is also possible to provide the fluid inlet in a different region and for the guidance to the flow-influencing element to be done via a fluid line.

The aperture leading into the cavity is preferably configured in such a way that the additive can be introduced into the cavity at a distance from a wall of the cavity. In particular, a distance between the wall and the aperture is 25-70%, in particular 35-50%, of the diameter of the tubular cavity.

The additive can therefore be introduced directly into the inner region of the hydraulically settable mixture that is conducted through, thereby resulting in particularly effective mixing.

In particular, the aperture leading into the cavity is configured in such a way that the additive can be introduced into the cavity in a direction substantially along the longitudinal axis of the tubular cavity or inclined with respect thereto. In particular, the additive is introduced in a direction which is at an angle of 0-45°, in particular 15-30°, with respect to the longitudinal axis of the cavity. The additive can therefore be added in the flow direction or slightly inclined with respect thereto, this having been found to be advantageous in terms of a homogeneous distribution which is as fast as possible.

The aperture leading into the cavity is preferably configured in such a way that the additive can be introduced into the cavity on a downstream side of the flow-influencing element. In other words, the aperture leading into the cavity is preferably present on the downstream side of the flow-influencing element. This makes it possible firstly to prevent hydraulically settable mixture from being pushed into the aperture when it is being conducted through and at the same time to minimize the pressure required to deliver the additive.

However, it is also possible to arrange the aperture leading into the cavity at the side of the flow-influencing element and/or in an upstream region.

As required, it is also possible to arrange multiple apertures in different regions of the flow-influencing element.

According to a particularly advantageous embodiment, the flow-influencing element is in the form of a cylindrical stub which projects into the cavity with its longitudinal axis in a direction substantially perpendicular with respect to the longitudinal axis of the cavity or in a radial direction of the cavity. In particular, in this respect the aperture leading into the cavity is present on the end face and/or the lateral surface of the cylindrical stub. An arrangement in a downstream side of the lateral surface is particularly preferred.

According to a further advantageous embodiment, the flow-influencing element is configured in such a way that it projects continuously to an increasing extent into the cavity along its length running in a longitudinal direction of the cavity, in particular in the flow direction.

In particular, the flow-influencing element has a leading edge which runs into the cavity inclined with respect to the flow direction from the upstream end to the downstream end. This has proven to be particularly advantageous in terms of the mixing action. In addition, this significantly reduces the risk of blockage.

According to a particularly preferred embodiment, the flow-influencing element is in the form of a fin, in particular a triangular fin. A “fin” is understood to mean in particular a planar element which has a small thickness compared to the length and height. The thickness is preferably at most 25% of the length or the width.

The fin preferably has a leading edge and an oppositely situated trailing edge, which are connected via two lateral surfaces, in particular two triangular lateral surfaces.

The fin is preferably a triangular fin. Such fins may be present, for example, in the form of a planar right-angled triangle. In this case, one or more corners may be rounded and/or one or edges may be curved.

A triangular fin is arranged in particular in such a way that one of its vertices projects into the cavity while a side of the fin opposite to the vertex is arranged on the wall of the cavity.

In principle, however, differently shaped fins may also be used.

The fin is preferably aligned along the longitudinal axis of the cavity in the region of the wall of the cavity or it is at an acute angle of 0-15°, in particular 1-10°, with respect to the longitudinal axis of the cavity. In this case, the fin may be used to locally separate the hydraulically settable mixture as it is conducted through. At the same time, the risk of blockage in the region of the fin is considerably reduced.

According to a particularly preferred embodiment, the fin is inclined with respect to a longitudinal axis of the cavity, with the result that the lateral surfaces of the fin are inclined with respect to the longitudinal axis of the cavity. The inclination is preferably > 0-15°, in particular 1-10°. This makes it possible to further improve the mixing action.

It has further proven to be advantageous if the fin is curved, in particular such that the first lateral surface is in the form of a concave surface and the second lateral surface is in the form of a concave lateral surface.

The leading edge of the fin preferably is at an angle of 20-60° with respect to the longitudinal axis of the cavity and/or the trailing edge is at an angle of 80-90° with respect to the longitudinal axis of the cavity.

The aperture for introducing the additive is preferably arranged on the trailing edge of the fin.

A cross-sectional area in the cavity of the device according to the invention, without taking into account the flow-influencing element(s), is preferably 100-1500 cm², in particular 500-1200 cm², specifically 600-800 cm² or approximately 706 cm². A diameter of the cavity at the widest point is preferably 50-300 mm, in particular 80-250 mm, specifically 120-180 mm or 150 mm.

The device preferably has connecting elements on the upstream side and/or on the downstream side. The connecting elements are preferably designed for attachment to pipelines and/or to connect multiple devices according to the invention to one another. The connecting elements may for example be in the form of flanges, clamps and/or screw connection elements.

According to an advantageous embodiment, there are at least two, in particular at least three, particularly preferably at least four, flow-influencing elements spaced apart from one another in a longitudinal direction of the cavity. In this respect, each of the flow-influencing elements is preferably a fin, in particular a triangular fin, specifically an inclined and/or curved fin, as described above.

By virtue of multiple flow-influencing elements connected one behind the other, the mixing action can be significantly enhanced.

The at least two flow-influencing elements preferably project into the cavity from different radial directions.

The radial directions of the at least two flow-influencing elements are preferably at an angle of 360°/(number of flow-influencing elements) with respect to one another. Given two flow-influencing elements, the angle is in particular 180°, given three flow-influencing elements it is 120°, and given four flow-influencing elements it is 90°.

Such an arrangement is beneficial for the mixing action. In principle, however, irregular arrangements at different angles are also possible.

In particular, the device comprises at least two, in particular at least three, preferably at least four individual devices as described above that can be detachably connected to one another, In this context, the devices are designed in such a way that they communicate with one another in the connected state by way of their tubular cavities.

In this case, the device may be in the form of an equipment set comprising at least two, in particular at least three, preferably at least four individual devices as described above that can be detachably connected to one another. In addition to the at least two devices according to the invention, the equipment set may contain additional connecting devices for connecting the devices according to the invention to one another and/or to external elements. It is likewise possible for the equipment set to contain for example one or more pipe portions, in particular pipe portions as are described below in connection with the arrangement according to the invention.

Given multiple devices that can be detachably connected to one another, or an equipment set, the mixing action and the addition of the additive can be adapted flexibly to specific conditions.

A further aspect of the present invention relates to an arrangement, in particular for delivering a hydraulically settable mixture, comprising at least one device as described above, wherein a pipe portion is arranged on the downstream side and/or on the upstream side, wherein, at least in one portion, the pipe portion has a free internal cross section which is smaller than the internal cross section of the cavity of the device according to the invention.

The free internal cross section in the pipe portion at the narrowest point is preferably smaller than the cross-sectional area in the cavity of the device according to the invention, without taking into account the flow-influencing element(s), by a factor of 0.2-0.8, in particular 0.3-0.5. A diameter of the pipe portion at the narrowest point is preferably smaller than the cross-sectional area in the cavity of the device according to the invention by a factor of 0.4-0.9, in particular 0.5-0.7.

A cross-sectional area in the pipe portion at the narrowest point is preferably 100-600 cm², in particular 200-400 cm², specifically 300-350 cm² or approximately 314 cm². A diameter of the pipe portion at the narrowest point is preferably 30-300 mm, in particular 50-200 mm, specifically 80-120 mm or 100 mm.

A pipe portion that tapers in the flow direction with respect to the free internal cross section is preferably attached to the downstream side. In particular, the free internal cross section in the pipe portion has a conical taper.

It has been shown that the combination of the device according to the invention with the tapering pipe portion makes it possible to enhance the mixing action still further, with the result that a homogeneous distribution of the additive can be achieved more quickly or over a shorter distance.

The free internal cross section in the tapering pipe portion preferably becomes smaller by a factor of 0.2-0.8, in particular 0.3-0.5, and in particular over a length of 0.25-2 m, preferably 0.5-1.5 m. On the one hand, this makes it possible to obtain additional mixing of the additive. On the other hand, the risk of blockages can be kept low.

It is further preferred when, at the same time, a second pipe portion tapering counter to the flow direction with respect to the internal cross section is attached to the upstream side, wherein the second pipe portion preferably tapers in a stepped manner. The cross section and diameter of the second pipe portion are preferably dimensioned as described above.

This restricts the volumetric flow flowing into the device according to the invention, with the result that the risk of blockages in the region of the flow-influencing elements can be reduced.

A further aspect of the present invention relates to the use of a device according to the invention or of an arrangement as described above to add and mix an additive into a hydraulically settable mixture. In this respect, the hydraulically settable mixture is defined as described above. In particular, it is a concrete or mortar composition.

In particular, the device or arrangement according to the invention is used in the production of shaped bodies by additive manufacturing and/or in the application of spray concrete or spray mortar.

“Additive manufacturing” refers to a process in which a three-dimensional object or a shaped body is produced by controlled spatial deposition, application and/or solidification of material.

For example, the additive manufacturing can be effected by a printhead that can be moved in at least one spatial direction, wherein the hydraulically settable mixture is conducted through a device or arrangement according to the invention before leaving the printhead.

The additive manufacturing can be effected for example as described in EP 3 558 679 A1, wherein, in addition to or instead of the metering device 21 depicted in FIG. 1, for the purpose of adding a hardening accelerator a device or arrangement according to the invention is connected in the feed line between the pump 25 and the printhead 20.

A process for applying spray concrete or spray mortar may be for example a dry or wet spray process. In this respect, the device or arrangement according to the invention is arranged upstream of the spray nozzle.

Specifically, the process for applying spray concrete or spray mortar may be a process as described in WO 2015/034438 A1. In this context, the spray concrete or spray mortar is sprayed into a prefabricated mesh, which is used as formwork, and built up to form a shaped body.

The invention also relates to a process for adding and mixing an additive into a hydraulically settable mixture by means of a device according to the invention or an arrangement as described above, wherein the additive is introduced into the hydraulically settable mixture through the aperture leading into the cavity.

The process is suitable in particular for the production of shaped bodies by additive manufacturing and/or for applying spray concrete or spray mortar.

In particular, in the case of the method according to the invention, the additive is metered depending on the volumetric flow of the hydraulically settable mixture delivered through the device. This makes it possible to precisely meter the quantity of additive, with the result that the desired action is achieved substantially constantly irrespective of the respective delivery rate of the hydraulically settable mixture.

According to a further advantageous embodiment, the additive is added by means of a device according to the invention containing at least two flow-influencing elements, wherein a first partial quantity of the additive is added through a first flow-influencing element, while at the same time at least one further partial quantity is added through at least one further one of the flow-influencing elements.

It has been shown that the addition of additives in partial quantities through multiple flow-influencing elements makes it possible to achieve an even more homogeneous distribution of the additive.

It is also advantageous when the aperture for introducing the additive at least at one flow-influencing element is subjected to and/or blown dry by a gas, in particular air, after the additive has finished being introduced. This may take place for example during an interruption in the delivery of the hydraulically settable mixture or after the process has finished.

It is therefore possible in particular, by virtue of the gas pressure, to prevent hydraulically settable mixture from entering the aperture(s) and blocking them.

Various exemplary embodiments are presented below, the purpose of which is to further elucidate the described invention. The invention is of course not limited to these described exemplary embodiments.

### BRIEF DESCRIPTION OF THE FIGURES

In the drawings that are present for the purpose of explaining the exemplary embodiments:

FIG. 1 shows a perspective view of a device according to the invention for adding and mixing an additive into a hydraulically settable mixture, having a curved, triangular fin as flow-influencing element;

FIG. 2 shows a view of the downstream side of the device from FIG. 1;

FIG. 3 shows a section along the line B-B from FIG. 2;

FIG. 4 shows a plan view of the device from FIGS. 1-3 in the direction of the fluid inlet through which an additive can be fed in;

FIG. 5 shows a schematic depiction of an arrangement having a device from FIGS. 1-4, wherein a pipe portion with a conical taper in the flow direction with respect to the free internal cross section is attached to the downstream end, and a second pipe portion tapering counter to the flow direction in a stepped manner is attached to the upstream end,

FIG. 6 shows a further arrangement comprising a set of four structurally identical and mutually connected devices, as depicted in FIGS. 1-4, with pipe portions attached thereto;

FIGS. 7a-d show variants of the invention having flow-influencing elements in the form of circular-cylindrical stubs, trapezoidal fins and rectangular fins with differently arranged apertures for introducing an additive.

### EXAMPLES

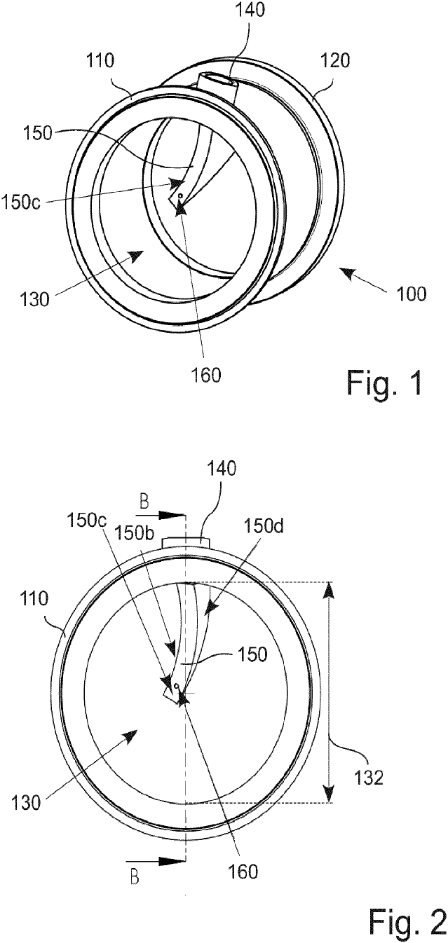

FIGS. 1-4 show a device 100 according to the invention for adding and mixing an additive into a hydraulically settable mixture.

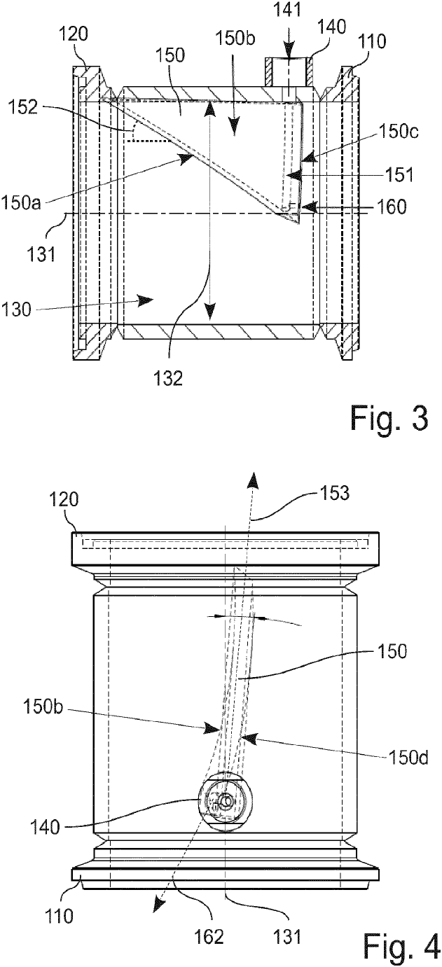

As can be seen from FIG. 1, the device 100 is present in the form of a circular-cylindrical pipe portion with a circular-cylindrical cavity 130, through which a hydraulically settable mixture can be conducted along the longitudinal axis 131 (see FIG. 3), which corresponds to the intended flow direction. There is a first annular fastening flange at the downstream end 110, while there is a second annular fastening flange at the upstream end 120. The device 100 can be attached to further tubular elements via the flanges.

A triangular and curved fin 150 in the form of a flow-influencing element projects into the cavity 130 from the inner wall of the device 100. An aperture 160 that leads into the cavity 130 and is intended for introducing an additive is arranged on the downstream trailing edge 150c of the fin 150.

The additive can be conducted from the outside to the aperture 160 through a fluid inlet 140 in the region of the fin 150 and a fluid channel 151 (see FIG. 3) running through the fin 150.

FIG. 2 shows a plan view of the downstream end 110 of the device 100. As can be seen from FIG. 2, the fin 150 is curved along its entire height, or in a radial direction. It includes a convex side 150d (visible in FIG. 2) and an oppositely situated and concavely curved lateral surface 150b (hidden in FIG. 2; see FIG. 4). The aperture 160 for introducing the additive is at a distance of approximately half of the diameter 132 from the wall of the circular-cylindrical cavity 130. The diameter 132 is for example approximately 150 mm.

In FIG. 3, which shows a section along the line B-B from FIG. 2, the triangular shape of the fin 150 can be seen. The fin 150 has a leading edge 150a running into the cavity 130 from the upstream end 120 in an inclined manner. The angle 152 between the leading edge 150a and the longitudinal axis 131, or flow direction, is for example approximately 30°. In this way, the fin 150 as flow-influencing element projects continuously to an increasing extent into the cavity 130 along its length running in a longitudinal direction 131 of the cavity 130.

The trailing edge 150c already depicted in FIGS. 1 and 2, which is approximately perpendicular with respect to the longitudinal axis 131, runs in the region of the downstream end of the fin 150.

A fluid channel 151 runs through a bore in the wall of the device 100 and inside the fin 150 from the fluid inlet 140, parallel to the trailing edge 150c, as far as the vertex of the fin 150. In the region of the vertex of the fin, the direction of the fluid channel 151 changes by 90°, with the result that the additive 141 to be poured in can be introduced into the cavity 131 in a direction with a main component along the longitudinal axis 131.

FIG. 4 shows a plan view of the device 100 in the direction of the fluid inlet 140. It can be seen here that the fin 150 runs in a direction 153 inclined with respect to the longitudinal axis 131 of the cavity in the region of the wall of the cavity 130, wherein the direction 153 is at an angle 153 of approximately 5° with respect to the longitudinal axis 131 of the cavity 130.

The aperture 160 is configured in such a way that a flow of additive leaving it runs in a direction 162 inclined with respect to the longitudinal axis 131 of the cavity. Specifically, the configuration is such that the additive can be introduced into the cavity in a direction 162 running at an angle of approximately 30° with respect to the longitudinal axis 131 of the cavity 130.

FIG. 5 shows a schematic depiction of an arrangement having a device 100 from FIGS. 1-4, wherein a pipe portion 200 with a conical taper in the flow direction 133 with respect to the free internal cross section is attached to the downstream end 110. The pipe portion 200 has for example a length of 1 m. In the region of its upstream end, the internal diameter of the pipe portion 200 corresponds to the diameter 132 of the cavity 130 of the device 100 of approximately 150 mm, while the internal diameter of the pipe portion in the narrowest region, or in the region of its downstream end, is approximately 100 mm.

A second pipe portion 300 tapering counter to the flow direction 133 in a stepped manner is furthermore attached to the upstream end 120 of the device 100. In the region of its end connected to the device 100, the internal diameter of the pipe portion 300 corresponds to the diameter 132 of the cavity 130 of the device 100 of approximately 150 mm, while the internal diameter of the pipe portion 300 in the tapered region, or in the region of its upstream end, is approximately 100 mm.

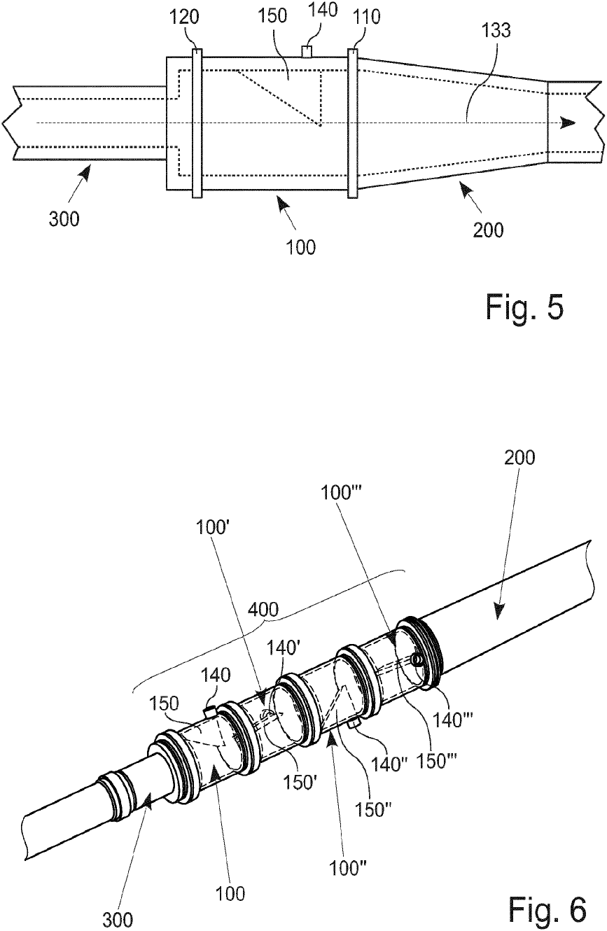

FIG. 6 shows a further arrangement comprising a set 400 of four structurally identical devices 100 according to the invention that are connected to one another. The second, third and fourth ones of the devices according to the invention are provided with the reference signs 100′, 100″, 100‴.

The four devices 100, 100′, 100″, 100‴ are detachably connected to one another over the respective flanges on the devices via clamps, with the result that a continuous cylindrical cavity is produced. In this respect, the second device 100′ has been rotated by 90° about the longitudinal axis with respect to the first device 100, with the result that the fin 150′ of the second device 100′ is at an angle of 90° with respect to the fin 150 of the first device 100. The third device 100″ has been correspondingly rotated by a further 90° with respect to the second device 100′ and the fourth device 100‴ in turn by a further 90° with respect to the third device 100″. In this way, all the fins 150, 150′, 150″, 150‴ point radially in four directions differing by 90°, while at the same time being spaced apart from one another in a longitudinal direction of the cavity.

It is possible to introduce, for example, partial flows of an additive, e.g. a solidification accelerator, into the cavity, or a hydraulically settable mixture conducted therethrough, through the fluid inlets 140, 140′, 140″, 140‴ of the four devices 100, 100′, 100″, 100‴. However, it is also possible to introduce a different additive at each of the fluid inlets 140, 140′, 140″, 140‴.

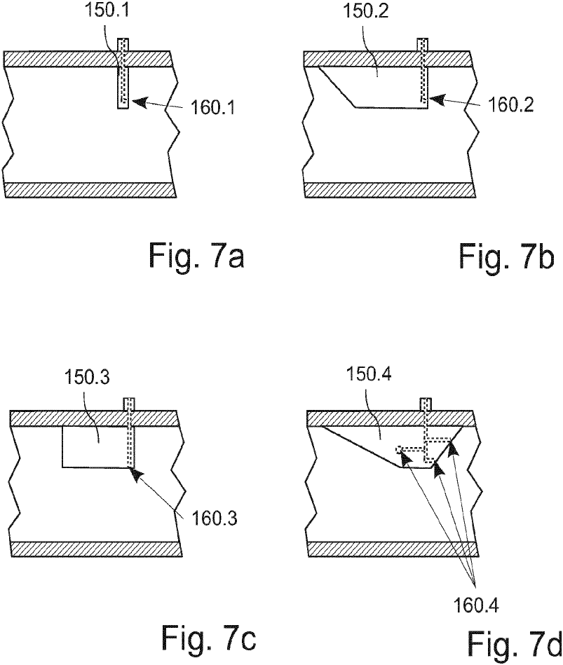

FIGS. 7a-7d show variants of the invention having differently configured flow-influencing elements. In FIG. 7a, the flow-influencing element is a circular-cylindrical stub 150.1, which, in the region of its free end on the lateral surface, has an aperture 160.1 for introducing an additive.

In the variant of FIG. 7b, the flow-influencing element is formed as a fin 150.2 in the form of a right-angled trapezoid, wherein the aperture 160.2 for introducing the additive is present on the downstream trailing edge.

FIG. 7c shows a variant having a rectangular fin 150.3. In this case, the aperture 160.3 for introducing the additive is located on the bottom side of the fin, with the result that the fluid can be introduced into the cavity in a radial direction.

In FIG. 7d, the flow-influencing element is a fin 150.4 in the form of a universal trapezoid without a right angle. In this case, the additive can be introduced through three apertures 160.4. Two of the apertures are located at different heights on the downstream trailing edge and one aperture is located on the lateral surface.

Further, tests with different arrangements were carried out to investigate the influence of the flow-influencing elements.

Experiment 1: A concrete composition was pumped at a constant throughflow rate through an arrangement as depicted in FIG. 6. In the process, a hardening accelerator modified with red dye was added and mixed in at a constant feed rate through the inlets 140, 140′, 140″, 140‴. The mixture created in this way was filled into a test tube attached to the pipe portion 200 and allowed to harden. After the hardening had taken place, the concrete body located in the test tube was transversely cut open and the cross sectional area was optically analyzed.

Experiment 2: The procedure took place as for Experiment 1. However, the fins 150, 150′, 150″, 150‴ were replaced by uncurved fins that had the same dimension and were aligned parallel to the longitudinal axis, or had no inclination.

Experiment 3: The procedure took place as for Experiment 1. However, the fins 150, 150′, 150″, 150‴ were replaced by flow-influencing elements as depicted in FIG. 7a.

Experiment 4: The procedure took place as for Experiment 1. In this case, the fins 150, 150′, 150″, 150‴ were completely removed, with the result that the accelerator was introduced only through bores in the wall of the devices 100, 100′, 100″, 100‴.

All experiments were carried out under identical conditions, except for the different flow-influencing elements.

The homogeneity of the distribution of the red dye, which constitutes a degree of distribution of the hardening accelerator, was optically assessed.

Specifically, the ratio of dyed cross-sectional area to non-dyed cross-sectional area was determined and evaluated on a scale of 1 (poor) to 6 (very good). Table 1 gives an overview of the results obtained.

TABLE 1

Test results

| Experiment | Flow-influencing element | Evaluation |
|---|---|---|
| 1 | Curved, inclined triangular fin | 5.33 |
| 2 | Uncurved and straight triangular fin | 5.25 |
| 3 | Circular-cylindrical stub | 4.83 |
| 4 | - | 2.96 |

The test results show that the addition and mixing in according to the invention of an additive with the aid of flow-influencing elements results in a significantly more homogeneous distribution of the additive for a hydraulically settable composition in comparison with conventional solutions (experiment 4). Particularly advantageous in this respect are flow-influencing elements in the form of fins (experiments 1 and 2), in particular when they are curved and inclined (experiment 1).

The arrangements according to the invention were furthermore utilized in additive manufacturing processes as described in EP 3 558 679 A1 and successfully tested. Similarly, the arrangements according to the invention were successfully tested for the purpose of applying spray concrete in processes as described in WO 2015/034438 A1.

However, the exemplary embodiments presented above should not be understood as having a limiting effect and can be modified as desired within the scope of the invention.

1. A device for adding and mixing an additive into a hydraulically settable mixture, comprising a tubular cavity for conducting the hydraulically settable mixture through in an intended flow direction, wherein a static flow-influencing element, in which there is an aperture that leads into the cavity and is intended for introducing the additive, projects into the cavity.

2. The device as claimed in claim 1, wherein the aperture leading into the cavity is configured in such a way that the additive can be introduced into the cavity at a distance from a wall of the cavity.

3. The device as claimed in claim 1, wherein the aperture leading into the cavity is configured in such a way that the additive can be introduced into the cavity on a downstream side of the flow-influencing element.

4. The device as claimed in claim 1, wherein the flow-influencing element has a leading edge extending into the cavity inclined with respect to the flow direction from its upstream end to its downstream end.

5. The device as claimed in claim 1, wherein the flow-influencing element is in the form of a fin.

6. The device as claimed in claim 5, wherein the fin is inclined with respect to a longitudinal axis of the cavity, with the result that lateral surfaces of the fin are inclined with respect to the longitudinal axis of the cavity, and/or wherein the fin is curved.

7. The device as claimed in claim 5, wherein a leading edge of the fin is at an angle of 20-60° with respect to the longitudinal axis of the cavity and/or the trailing edge is at an angle of 80-90° with respect to the longitudinal axis of the cavity.

8. The device as claimed in claim 1, wherein there are at least two flow-influencing elements spaced apart from one another in a longitudinal direction of the cavity.

9. The device as claimed in claim 8, wherein the radial directions of the at least two flow-influencing elements are at an angle of 360°/(number of flow-influencing elements).

10. The device as claimed in claim 8, wherein the device comprises at least two individual devices for adding and mixing an additive into a hydraulically settable mixture, comprising a tubular cavity for conducting the hydraulically settable mixture through in an intended flow direction, wherein a static flow-influencing element, in which there is an aperture that leads into the cavity and is intended for introducing the additive, projects into the cavity, that can be detachably connected to one another, wherein the devices are designed in such a way that they communicate with one another in the connected state by way of their tubular cavities.

11. An arrangement comprising at least one device as claimed in claim 1,wherein attached to the downstream side there is a first pipe portion that tapers in the flow direction with respect to the internal cross section, wherein the internal cross section in the first pipe portion has a conical taper, and wherein attached to the upstream side there is a second pipe portion tapering counter to the flow direction with respect to the internal cross section, wherein the second pipe portion tapers in a stepped manner.

12. A method comprising using the device as claimed in claim 1 in the production of shaped bodies by additive manufacture and/or in the application of spray concrete or spray mortar.

13. A process for adding and mixing an additive into a hydraulically settable mixture, by means of a device or an arrangement as claimed in claim 11, wherein the additive is introduced into the hydraulically settable mixture through the aperture leading into the cavity.

14. The process as claimed in claim 13, wherein the additive is added by means of a device for adding and mixing an additive into a hydraulically settable mixture, comprising a tubular cavity for conducting the hydraulically settable mixture through in an intended flow direction, wherein a static flow-influencing element, in which there is an aperture that leads into the cavity and is intended for introducing the additive, projects into the cavity, wherein there are at least two flow-influencing elements spaced apart from one another in a longitudinal direction of the cavity and wherein a first partial quantity of the additive is added through a first flow-influencing element, while at the same time at least one further partial quantity is added through at least one further one of the flow-influencing elements.

15. The process as claimed in claim 13, wherein the apertures leading into the cavity are subjected to and/or blown dry by a gas after the additive has finished being introduced.
